(19) United States
(12) Patent Application Publication
(10) Pub. No.: US 2002/0094942 A1
(43) Pub. Date: Jul. 18, 2002

(54) Fabric additive articles and package therefor

(75) Inventors: Allison Jane Danneels, Brussels (BE); Laure Waegemans, Bruxelles (BE); Julie Savchenko, Cincinnati, OH (US); Errol Hoffman Wahl, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 09/946,375

(22) Filed: Sep. 5, 2001

Related U.S. Application Data
(60) Provisional application No. 60/230,338, filed on Sep. 6, 2000.

(51) Int. Cl. C11D 17/00

(52) U.S. Cl. 510/295; 510/296; 510/297

(57) ABSTRACT

The present invention provides an article of manufacture or package for containing and dispensing unitized doses of a laundry additive in article form. The package comprises a plurality of laundry additive articles, means for preventing exposure of the laundry articles to moisture prior to dispensing or use, and a container having a compartment and closure for enclosing the plurality of articles in the container. The container can be a tub, tray, jar, bottle, pouch, bag, box or some combination thereof and will preferably be made from polymeric materials. Optionally, the container may have dividing means for subdividing the container compartment into subcompartments so that the container can accommodate a variety of different additives in separate compartments. Optionally, but preferably, the container closure will have child resistant features as well as a window or other means for viewing the contents of the package when the closure is in a closed position. The means for preventing exposure of the articles to moisture may simply be a seal about the container closure or it may comprise separate a seal for each laundry additive article. Seals for the individual articles will preferably be a tray with a recess formed therein for receiving the laundry additive article and a polymeric film adhered to the tray over the recess to seal the article within.

### CROSS-REFERENCE TO RELATED APPLICATION

This patent application claims the benefit of U.S. Provisional Application Serial No. 60/230,338 filed Sep. 6, 2000 by Danneels et al.

### BACKGROUND OF THE INVENTION

1 . Field of the Invention

The field of the present invention concerns containers and packaging for laundry products in article and/or unitized dose form. The laundry products include additives for use in both the wash and rinse cycles and include, but are not limited to, detergents, fabric softeners, and perfumes among others. These laundry products are in article or unitized dose form but specifically include solids, pastes, gels and liquids. Non-solid laundry additives will most commonly be encapsulated in film materials that are at least partially soluble in water.

2. Description of the Prior Art

Containers for use in distributing and storing unitized doses of laundry additive articles are not well known in the art. However, the convenience associated with such dosing has generated renewed interest in commercializing this laundry additive form and therefore appropriate packaging for such forms is needed.

In general, these additive forms are water soluble and thus need at least some degree of protection from moisture including atmospheric moisture to prevent the additive articles from degrading prior to use. It is also desirable to provide a package for such additives that has features to prevent a damaged and possibly leaking additive article from contaminating the other articles in the package. Likewise, such a package should also prevent damaged articles from leaking additive materials from the package and contaminating surfaces adjacent the package.

In addition, many of these additive forms are fragile and can be easily crushed, punctured or otherwise damaged during handling, transport and storage. Further still, because many of these forms are relatively small in size and are commonly dyed or colored for various purposes, packaging for these additives should also have features to prevent or inhibit children from accessing the laundry additive without assistance.

Therefore, there remains a need for laundry additive packaging that will provide adequate protection for a plurality of additive articles from moisture, physical damage due to handling, transport or storage as well as providing child resistant features. It is also an object of the present invention to provide a package having a window or other means that will enable the consumer to view the contents of the package when the package is closed.

### SUMMARY OF THE INVENTION

The present invention provides an article of manufacture or package for containing and dispensing unitized doses of a laundry additive in article form. The package comprises a plurality of laundry additive articles, means for preventing exposure of the laundry articles to moisture prior to dispensing or use, and a container having a compartment and closure for enclosing the plurality of articles in the container.

The container can be a tub, tray, jar, bottle, pouch, bag, box or some combination thereof and will preferably be made from polymeric materials. Optionally, the container may have dividing means for subdividing the container compartment into subcompartments so that the container can accommodate a variety of different additives in separate compartments. Optionally, but preferably, the container closure will have child resistant features as well as a window or other means for viewing the contents of the package when the closure is in a closed position.

The means for preventing exposure of the articles to moisture may simply be a seal about the container closure or it may comprise a separate seal for each laundry additive article. Seals for individual articles will preferably comprise a tray with a recess formed therein for receiving the laundry additive article and a polymeric film adhered to the tray over the recess to seal the article within.

### BRIEF DESCRIPTION OF THE DRAWINGS

FIG. 1 is a perspective view of a package of the present invention showing the container divided into sub-compartments and the laundry additive articles having individual sealing means to prevent exposure of the article to moisture prior to use.

FIG. 2a is a perspective view of a package of the present invention showing the closure means in a closed position with means for viewing the contents of the container.

FIG. 2b is a perspective view of the package in FIG. 2a showing the container divided into sub-compartments and the laundry additive articles having individual sealing means to prevent exposure of the article to moisture prior to use.

FIG. 2c is an elevated view of the laundry additive articles container having individual sealing means to prevent exposure of the article to moisture prior to use.

FIG. 3a is an elevated view of the laundry additive articles container having individual sealing means to prevent exposure of the article to moisture prior to use.

FIG. 3b is a cross sectional view of the laundry articles of FIG. 3a.

FIG. 4 is a perspective view of an alternative embodiment of the package of the present invention showing the container with dividing means.

FIGS. 5a-5c are perspective views of a cylindrical container not unlike that of FIG. 4 but with a closure at the top.

FIGS. 6a-6c are perspective views of an alternate form of the present invention showing a container with a triangular cross section.

FIGS. 7a-7d are perspective views of an alternate form of the present invention having a blister package arrangement.

FIGS. 8a-8b are perspective views of an alternate form of the present invention having a blister package arrangement that folds over for insertion in an outer sleeve.

FIGS. 9a-9d are perspective views of an alternate form of the present invention similar to that shown in FIGS. 1 and 2b.

### DETAILED DESCRIPTION OF THE PREFERRED EMBODIMENTS

The article of manufacture of the present invention is a package that comprises a plurality of laundry additive articles, means for reducing and/or preventing exposure of the laundry articles to moisture prior to dispensing or use, and a container having a compartment and closure for enclosing the plurality of articles in the container.

The laundry articles of the present invention are preferably a unitized dose of a laundry composition, such as a detergent or fabric care composition. While such articles can have a variety of forms, shapes and compositions, a common feature of such additives is their susceptibility to being degraded, deactivated, rendered unstable or dissolved when exposed to prolong and/or high levels of moisture. By way of example, laundry additives encapsulated in polymer films that are designed to be fast dissolving under both hot and cold water conditions, may become tacky, unstable and even prematurely dissolve if not protected from prolonged exposure to atmospheric moisture. Such articles are described in Applicant's co-pending application entitled Concentrated Fabric Softening Compositions And Articles Containing Such Compositions, Caswell, et al., U.S. Ser. No. 09/852,940 filed May 10, 2001, which is incorporated herein by reference.

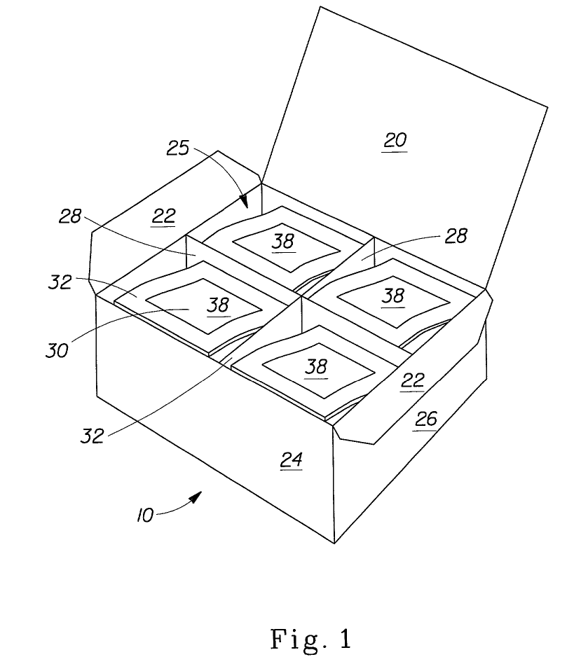

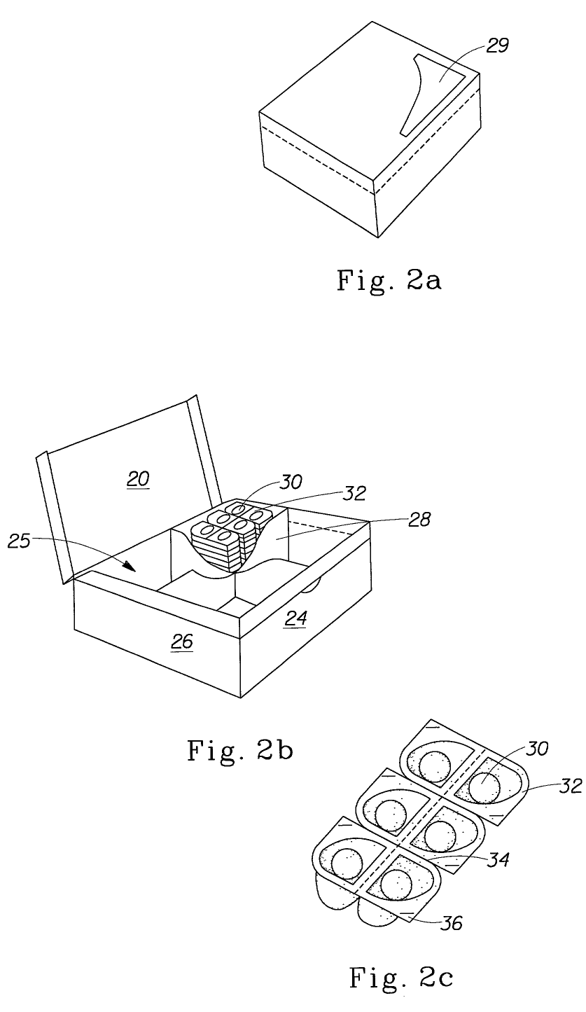

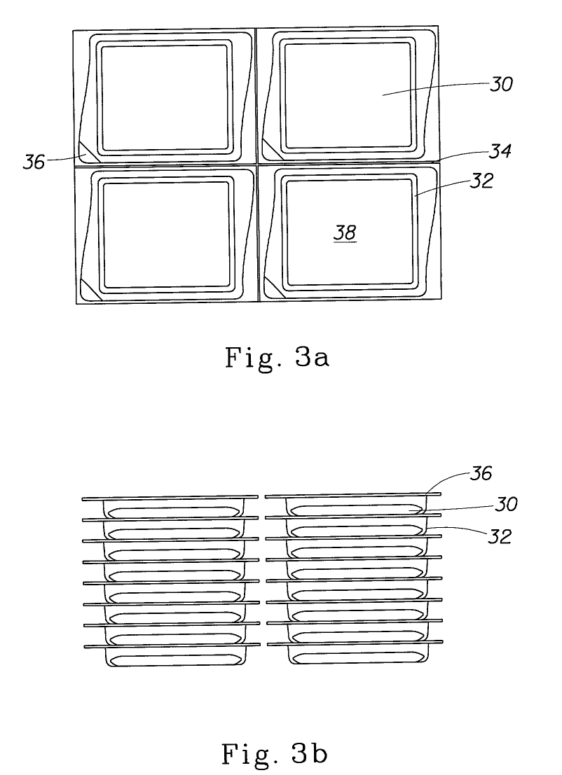

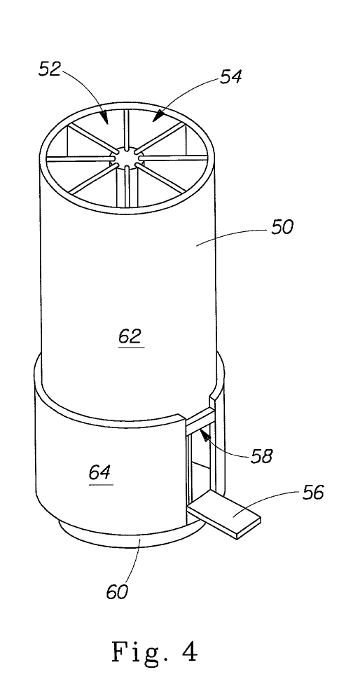

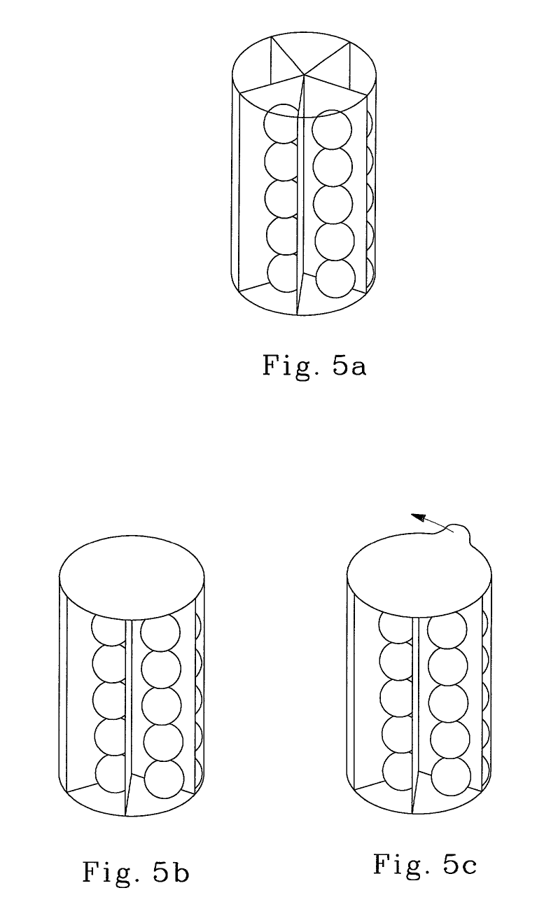

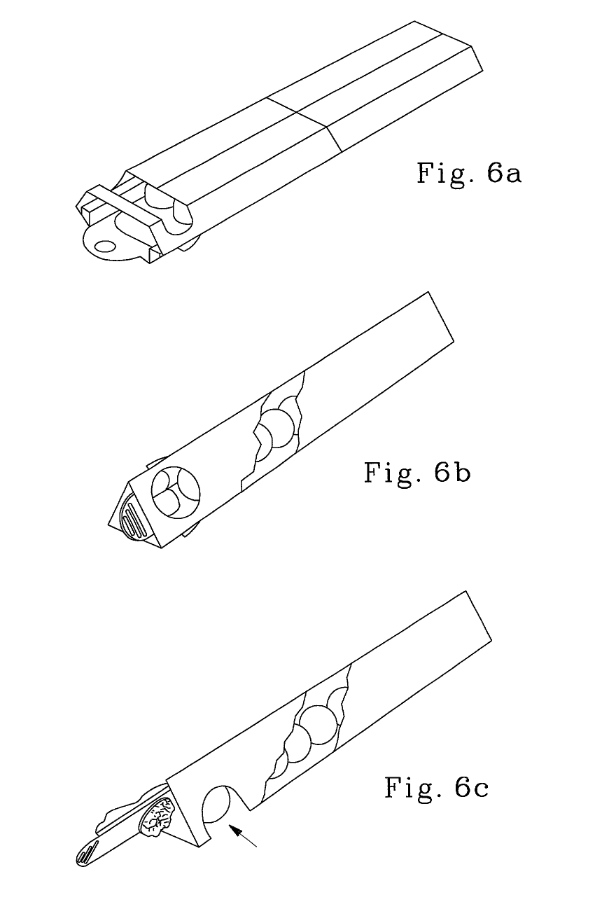

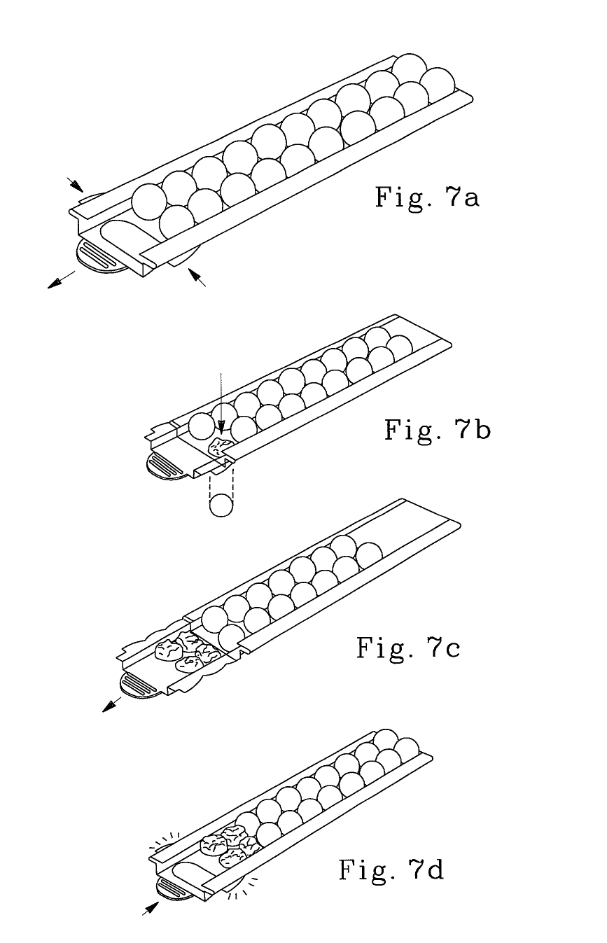

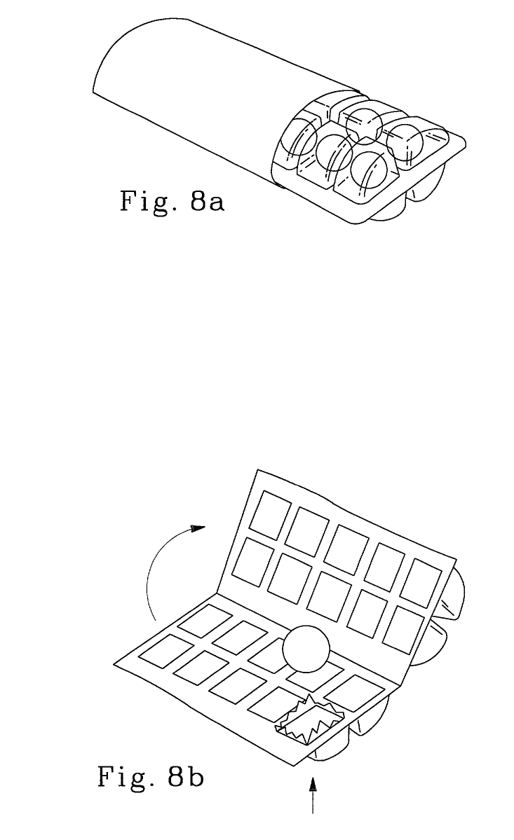

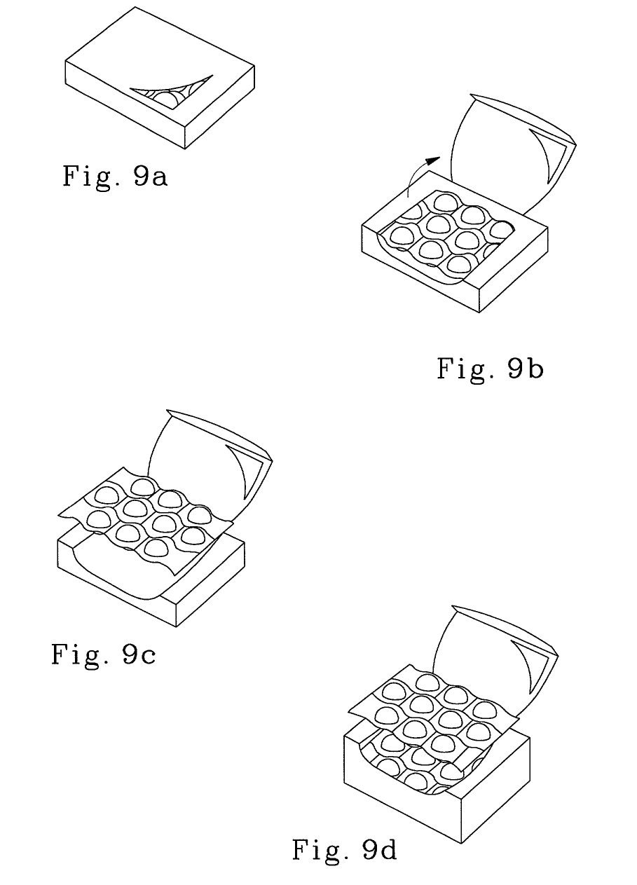

FIG. 1 shows a container generally at 10. Although the container is described and illustrated in FIGS. 1-2c as a box and as a cylindrical bottle in FIG. 4, the container of the present invention need not have a particular form provided that it has a compartment for containing a plurality of laundry articles and a closure for enclosing the laundry additive articles within that compartment. Therefore, different containers that may be used in the present invention include tubs, trays, jars, cylindrical bottles, pouches, bags, and combinations thereof. An example of a tub or box that is useful as a container for the present invention is disclosed in U.S. Pat. No. 6,092,690, “Wet-Wipe Container Having a Hinged Cover, issued to The Procter & Gamble Company, which is incorporated herein by reference. A variety of containers having different features of the present invention are illustrated in FIGS. 5a-9d.

As illustrated in FIG. 1, container 10 has compartment 25 that is defined by a bottom wall (not shown), front and rear walls 24, side walls 26 and closure 20. An optional, but highly preferred feature of the container of the present invention are dividing means 28 within container compartment 25. As illustrated in FIGS. 1 and 2b, dividing means 28 may simply be intersecting walls that divide the compartment into subcompartments. Division of the compartment into sub-compartments facilitates the packaging of different types of additive articles in the same package, facilitates the removal of individual articles by the consumer, and prevents contamination in one compartment from spreading to the entire container. It is envisioned that contamination may occur due to a damaged article within the container or the introduction of moisture or other materials from external sources.

Another preferred feature is the incorporation of a window or other means that will enable the consumer to view the contents of the container when closure 20 is in a closed position. As shown in FIG. 2a, closure 20 may be provided with window 29 to enable the consumer to view the laundry additives within. Alternatively, the container and/or closure may be made of transparent or translucent materials that will enable the consumer to view the contents of the container.

The container in FIG. 1 does not have specific means for preventing moisture from entering compartment 25. Although not shown, container 10 can have a seal about the top of the side walls and the front and rear walls for engaging with the edges of closure 20 when closure 20 is in a closed position. Alternatively, container 10 may be formed so that closure 20 fits snugly up against the upper edges of the walls of the container to prevent the entry of moisture into compartment 25 when it is held in a closed position. Preferably, a snap closure or similar conventional fastening means can be used to secure the closure to the container. Alternatively, the upper portions of the container and closure can be formed with complementary features to allow the container and closure to be secured to one another in a snap-fit or threaded engagement.

In a preferred embodiment where individual sealing or wrapping of the laundry articles is not desired or needed, it is preferred that the closure have an opening formed therein, a lid that is preferably hingedly attached to the closure near the opening, and lid fastening means, preferably undercuts formed on the periphery of lid's lower surface, to provide a snap closure over the opening. In this embodiment, the closure need not be removed to dispense the laundry articles. To dispense the articles, the lid may be easily flipped open, one or more articles dispensed, and the lid quickly re-secured over the opening.

As illustrated in FIG. 1, the means for preventing exposure of the laundry additive articles 30 to moisture is provided by sealing means about each individual laundry article. Specifically, articles 30 rest within a recess formed in tray 32. Adhered and sealed to the upper surface of tray 32 is a over wrap 38 which prevents the entry of moisture even when container closure 20 is in an open position. This sealing means is not unlike the blister packaging that is presently used for containing and protecting a variety of pharmaceutical products. Thus, by way of example, the sealing means of the present invention may also include blister packaging such as that which is disclosed in U.S. Pat. No. 4,243,144 “Bend and Peel Blister Strip Package” issued to Sterling Drug, Inc. and U.S. Pat. No. 5,109,984 “Unit-Dose Medication Handling and Dispensing System, issued to Jerome M. Romick, both of which are incorporated herein by reference. The use of tray 32 provides not only protection against moisture, but provides structural support around the laundry additive articles to prevent damage thereto. Further, tray 32 can be formed to facilitate the stacking of trays and articles within a container.

As described above, where individual containment of each article is not needed and/or desired, means for preventing exposure of the articles to moisture will comprise fastening for tightly securing the closure to the container. As noted above, such securing means may comprise a simple snap closure or threads that will provide a tight fit and seal between the closure and container edges. Optionally, a seal in the form of strips of a resilient material can be used along the edges of the container and/or closure to ensure a tight fit between the container and closure.

Materials that can be used to form the containers, sealing means and other elements of the present invention include a variety of conventional cellulose and polymer based materials. Costs and ease of manufacture are primary factors when selecting these materials. Likewise, because the materials will serve as a moisture barrier between the article and the atmosphere, it is preferred that the materials have a moisture transmission rate of less than about 5, preferably less than about 1, even more preferably less than about 0.5, and still more preferably less than 0.15. Moisture vapor transfer rates may be determined under ASTM F1249-90% at 38° C./90% relative humidity (g/m²/24 hours).

In a preferred embodiment, the container will be made from a cellulose material such as a card stock or cardboard that has been coated with a water resistant coating. Preferably, the sealing means for individual laundry articles will be made from a variety of polymers such as thermoformable polymers that may be easily formed into blister packaging or other desired forms.

In a second but preferred embodiment where it is not needed or desired that the articles be individually wrapped or sealed, the container will comprise a generally cylindrical tub or jar with a top closure that are both vacuumed formed from a thermoformable polymer. Preferred thermoformable polymers will include HIPS—high impact polystyrene, PET—polyethylene terephthalate, PP—polypropylene, and HDPE—high density polyethylene. In this preferred embodiment, the top is secured to the tub after the articles have been placed within the compartment. To simplify the opening, dispensing and closing of the container, the top is provided with an opening and a hinged lid that has a snap closure. When in a closed position, the lid securely covers the opening and prevents the entry of moisture into the compartment.

It may also be preferred to limit access to the laundry additive articles particularly with respect to children. As such, it is desirable to incorporate child resistant features into the container closure, or in the alternative, into the sealing means for the individual laundry additive articles. The incorporation of child resistant features into blister packaging is disclosed in U.S. Pat. No. 4,243,144 cited above. Likewise, closures such as tops and lids that must be lined up in a certain orientation before they will release, or that require the performance of a certain sequence of steps or actions to actuate their release, may be incorporated into the closure itself or into the sealing means.

The articles 30 are shown in FIG. 1 as having a relatively planar shape that may generally be described as a pillow or pouch. The articles 30 shown in FIGS. 2b and 2c are more spherical in nature and are generally referred to as a bead. Although the shape of the articles in FIGS. 2b and 2c are somewhat different, the sealing means for the individual articles can be the same. Specifically, articles 30 are shown resting in a recess formed in tray 32 and are sealed therein by over wrap 38 that is affixed to the upper surface of tray 32. As show in FIG. 2c, multiple trays can be joined together with perforations or a seam therebetween to allow individual trays to be removed. In addition, tab 36 is provided to aid in removing over wrap 38 from tray 32. Again, it is preferred that tray 32 provide protection from moisture and physical damage to the individual articles and even more preferably, that the trays be stackable to facilitate packaging.

FIG. 4 illustrates another embodiment of the present invention in container 50. Container 50 is generally a cylindrical container having bottom 60, a fixed base 64 and an upper rotating portion 62 resting within base 64. Container 50 has compartment 54 that is defined by the bottom, base, upper rotating portion and a top that is not illustrated. An opening 58 and closure 56 is provided in base 64 to allow the consumer to dispense laundry additive articles therefrom. Compartment 54, is subdivided into multiple subcompartments 52 which allow multiple types of additives to be included in the container. As described above, it is most preferred that the container prevent the entry of moisture into the container when closure 56 is in a closed position.

In use, the upper rotating portion 62 may be rotated so that the desired additive in a given sub-compartment is adjacent the opening 58. Closure 56 is moved to an open position enabling the article to be dispensed from the container. A clear top or a window in the top affixed to container 50 would facilitate the identification of the contents of each sub-compartment although providing such identification information on the container would also serve this function. Likewise, it is preferred that container 50 be provided with child resistant features to prevent young children from having access to the contents of the container.

The containers of the present invention may also be configured to facilitate the dispensing of laundry additive articles. For instance, it is anticipated that a device such as that disclosed in U.S. Design Patent 345,481, “Gravity Feed Dispenser for Medicinal Packets” may be used to contain and dispense individually sealed laundry articles of the present invention.

What is claimed is:

1. A package for containing and dispensing unitized doses of a laundry additive in article form, the package comprising:
a plurality of laundry additive articles;
a container having a compartment for containing the plurality of articles; and
a closure for the container, the closure having means for reducing the exposure of the laundry articles to moisture prior to their dispensing and use.

2. The package of claim 1, wherein the container has dividing means for dividing the container compartment into sub-compartments.

3. The package of claim 1, further comprising child resistant means to deter a child from opening the package.

4. The package of claim 1, wherein the means for reducing exposure of the articles to moisture comprises means for sealing each individual laundry additive article.

5. The package of claim 4, wherein the means for sealing each individual laundry additive article is a tray with a recess formed therein for receiving the laundry additive article and a polymeric film adhered to the tray over the recess.

6. The package of claim 1, wherein the means for reducing the exposure of the laundry articles to moisture comprise a sealing engagement between the container and closure and fastening means for securing the closure to the container.

7. The package of claim 1, wherein the means for reducing the exposure of the laundry articles to moisture comprises an opening in the closure, a lid to fit about the opening, and lid fastening means for securing the lid about the opening.

8. The package of claim 1, wherein the container is a tub, tray, jar, bottle, pouch, bag, box or a combination thereof.

9. The package of claim 1, wherein the container is made of polymeric materials.

10. The package of claim 9, wherein the container is made of a thermosetting polymer.

11. The package of claim 1, wherein the closure has means for viewing the contents of the package when the closure means is in a closed position enclosing the plurality of laundry additive articles in the container.
